(19) United States
(12) Patent Application Publication
(10) Pub. No.: US 2005/0025172 A1
(43) Pub. Date: Feb. 3, 2005

(54) Method and apparatus for secure distributed collaboration and communication

(76) Inventor: Justin Frankel, San Francisco, CA (US)

Correspondence Address: GLENN PATENT GROUP, 3475 EDISON WAY, SUITE L, MENLO PARK, CA, 94025, US

(21) Appl. No.: 10/631,436

(22) Filed: Jul. 30, 2003

(51) Int. Cl. H04J 3/16

(52) U.S. Cl. 370/437; 370/338

(57) ABSTRACT

The invention comprises a system that permits secure distributed collaboration and communications for small trusted groups of people. The presently preferred embodiment of the invention allows users to communicate and transfer information easily and effortlessly. The invention requires very little administration, and no central server or central administration is required.

### BACKGROUND OF THE INVENTION

1. Technical Field

The invention relates to a generic virtual secure private network upon which other services can be built. More particularly, the invention relates to a method and apparatus for secure distributed collaboration and communication.

2. Description of the Prior Art

Peer-to-peer systems, such as Gnutella, and variants including BearShare and LimeWire, are known. The typical peer-to-peer architecture is best understood when contrasted with traditional client server models of networking, which can be thought of as a classroom where the students ask questions and only the teacher is allowed to answer them. The teacher is the server and the students are the clients. A peer-to-peer architecture is like a classroom full of teachers where they all ask each other questions and they all share the information they have. Just as every student in this classroom is a teacher, every client is a server in a peer-to-peer network.

The Gnutella protocol is a protocol that follows the peer-to-peer model. When one uses a Gnutella program such as Bearshare to do a search, it is executed as in a game of telephone. In the game of telephone, a person tells a message to the person next to him and that person passes the message on to the person next to them and so on. In Gnutella, a requestor sends a search query to all the computers to which it is connected, i.e. its peers. They return their results to the requestor and pass the query on to each of the computers to which they are connected. This process continues and scans the Gnutella-net for the file for which the requester is looking.

Unfortunately, known peer-to-peer systems operate in a public space, i.e. the Internet, and in an insecure manner. Thus, such prior art systems lack the security and trust mechanisms that are essential for secure collaboration and communication. It would be advantageous to provide a system that permits secure distributed collaboration and communications for trusted groups of people.

### SUMMARY OF THE INVENTION

The invention comprises a system that permits secure distributed collaboration and communications for small, trusted groups of people. The presently preferred embodiment of the invention allows users to communicate and transfer information easily and effortlessly. The invention requires very little administration, and no central server or central administration is required.

### BRIEF DESCRIPTION OF THE DRAWINGS

FIG. 1 is a block schematic diagram of a peer-to-peer network according to the invention;

FIG. 2 is a block schematic diagram showing a message according to the invention; and

FIG. 3 is a flow diagram showing a link connection negotiation scheme according to the invention;

FIG. 4 is a flow diagram showing a random number generation scheme according to the invention; and

FIG. 5 shows a user display according to the invention.

### DETAILED DESCRIPTION OF THE INVENTION

The invention comprises a system that permits secure distributed collaboration and communications for small trusted groups of people. The presently preferred embodiment of the invention allows users to communicate and transfer information easily and effortlessly. The invention requires very little administration, and no central server or central administration is required.

The preferred embodiment uses a fully distributed network for all communications. No direct connections are brought up on demand, rather all services run through the distributed network. The network is encrypted on the link layer, using technology similar in function to secure socket layer (SSL), although the invention does not sacrifice security by removing the need for a certificate authority.

Network Architecture

The presently preferred embodiment routes all data through a distributed ad-hoc network. The network structure can adapt for traffic, and is fairly organized based on capacity. When moving large amounts of data, the network is redundant and load-balanced. Both redundancy and load balancing may be accomplished using known techniques. Because all data transfer is accomplished through this distributed network, firewalls do not impair function as long as there are hosts on the network that are accessible from everywhere. Nodes can also throttle their bandwidth usage to optimize network use.

The invention keeps the private network private by only connecting or allowing connections between known users, and by using strong encryption to secure those links. Once a network is up, users do not have to worry about IP addresses to which to connect, fire walled machines, or other network topologies. As long as the user can connect to any other host on the network, the user can access all of the services of the network. All of this happens automatically.

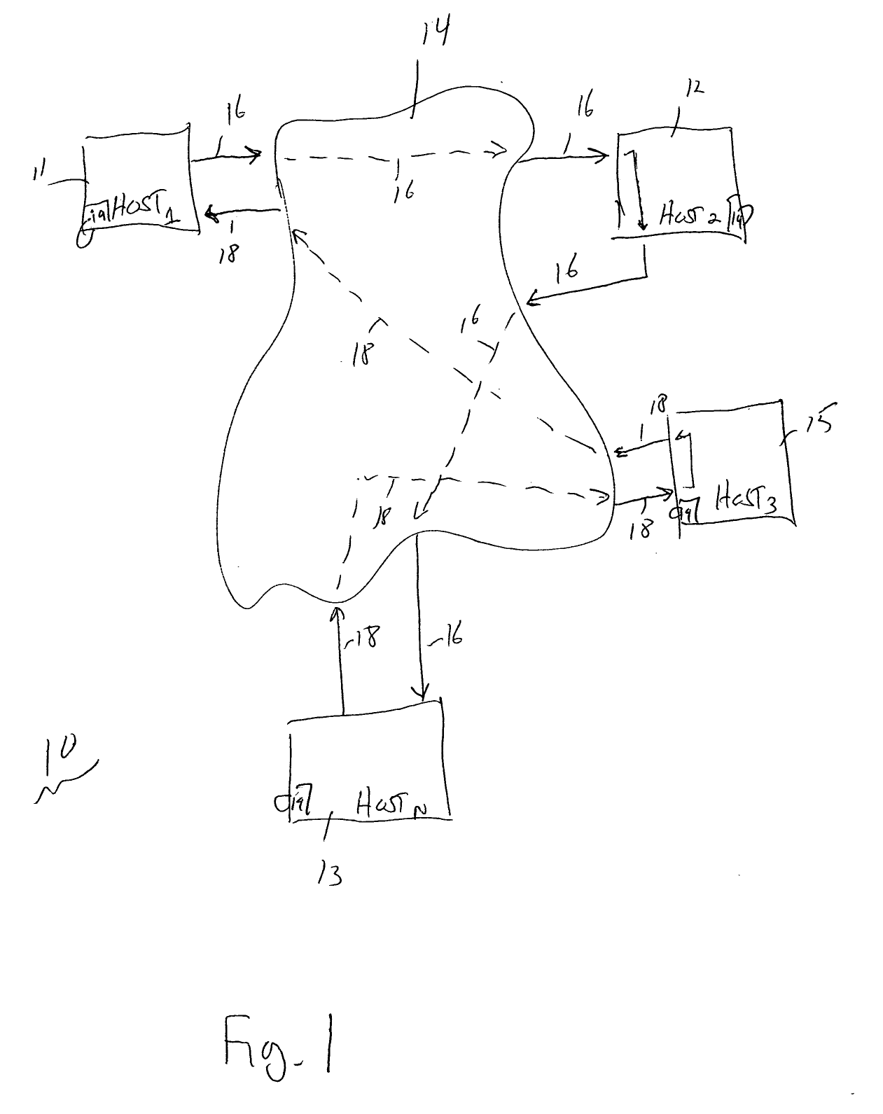

The invention is built upon an underlying distributed network architecture that is similar to that of Gnutella. See FIG. 1, which is a block schematic diagram of a peer-to-peer network 10 according to the invention, in which a plurality of hosts, Host₁, Host₂, Host₃, Hostₙ (11, 12, 13, 15) communicate via a network 14. The preferred embodiment consists of a distributed peer-to-peer network that allows communication between hosts based on the model of broadcast request routed reply, where a host sends out a broadcast message to the network 16, and zero or more hosts send routed replies that follow the path 18 of the broadcast message back to the sender. Note that the broadcast and reply pasts may take different routes, as indicated in FIG. 1. Link level security and user identification and registration is implemented by providing a security module 19 at each host (discussed below).

The preferred embodiment uses 128 bit IDs for each new broadcast message, so that each node can track which broadcast messages it has seen, and so that it can send routed messages back to the point of origin for the original broadcast message. Due to the logic of each node on the network, if there are multiple paths to a particular node from another node, the path that took the least time to broadcast is used for the routed reply, as shown in FIG. 1.

Nodes on the network can decide whether or not to rebroadcast or route traffic based on their connection type. Modem nodes communicating with nodes on T1s/DSL generally do not route due to their low bandwidth capability. In the preferred embodiment, each node organizes a queue of messages for each connection, and prioritizes messages in the queue as appropriate for optimal network performance.

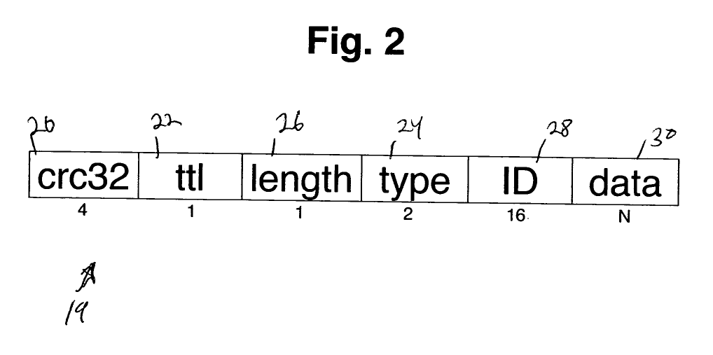

The preferred embodiment has a basic protocol for sending messages that involves the following information per message (see FIG. 2, which is a block schematic diagram showing a message 19 according to the invention):
Four bytes CRC32 of message 20: For verifying the integrity of the messages.
One byte TTL of message 22: Used to prevent broadcast messages from saturating the network in the rare instance where multiple hosts have their routing tables overflowed, or a slow node gets very far behind in broadcasting.
One byte message type 24: Contains information on what kind of message this is, as well whether or not it is a broadcast message, routed message, or local message.
Two bytes message length 26, maximum of 32 kb for routed messages, 2 kb for broadcast messages.
Sixteen bytes (128 bit) message ID 28.
<N message length bytes>message data 30, dependent on the message type.

The underlying design of the network and the basic services that run on it requires that the following conditions be met for the network to function optimally:
The number of nodes on the network should be small because the amount of traffic on the network scales more than linearly with the number of users.
Each node on the network should trust other users on the network because messages are inherently broadcasted, often unnecessarily, to many nodes on the network, and data is routinely routed through other nodes on the network.

The invention provides a generic virtual secure private network upon which other services can be built. Currently, the following services have been implemented for use on the network:
Instant Messaging—this application allows users to communicate with other users on a private network in much the same way as when using such services as AIM or ICQ. This feature is primarily accessed through the main window (discussed below). Text messages are broadcasted on the herein disclosed network, along with information on the sender and the recipient. Routed replies inform the sender of the instant message when the recipient has received the message, and how long it took to go round trip.

Group chat—this application allows two or more users to chat on a network in much the same way as when using such services as AIM, ICQ, or IRC. This feature is primarily accessed through the main window (discussed below). Text messages are broadcasted on the herein disclosed network, along with information on the sender and the destination channel name. Automated notification messages, such as when a user joins or departs a channel, are sent via the same means. Routed replies are sent when a user receives a channel message, so that the sender can see who on the channel has gotten the message, and if not, the client can determine that the user has “pinged out.”
Distributed presence—this application allows users to see which other users are currently on a private network. This feature is primarily accessed through the main window (discussed below), and facilitates ease in Instant Messaging. Two methods are currently used to let each user have a reliable prediction of who is on the network at any given time. The first method consists of each user periodically broadcasting, especially on each new connection brought up, its existence on the network so that other users can see when a new user comes on, and detect when the user is no longer broadcasting their existence. In the second method, a user can send a broadcast message to request replies with user names. This allows a user to get a full list of who is on the network quickly. Users detect when other users go offline when no activity from that user has been seen in a specified amount of time.
File browsing—this application allows users to browse a virtual directory structure for each user on the network. Each user can specify a list of directories to make available to other users on the network. This feature is primarily accessed through the browser window (discussed below). File browsing is preferably accomplished by sending a broadcast message with a browse path to the network, to which each host may send routed replies with any results it may have.
File searching—this application allows users to search other users' databases. Each user can specify a list of directories to make available to other users on the network. In the presently preferred embodiment, searching for filenames and directory names is supported. However, full-text searching and meta-searching can be added. File searching is accomplished by sending a broadcast message with a search specification to the network, to which each host may send routed replies with any results it may have.
File transfer—this application allows users to transfer files to or from other users. Files can be found via the file browsing and file searching features discussed above, or files can be uploaded to other users manually. This feature is accessed through many interfaces, and can be managed with a file transfer window. Efficiently implementing file transfer is a bit more complex than the other services, but it also demonstrates the flexibility of the underlying network architecture.

When a node wishes to download a file, or portion of a file, from another node, the requesting node broadcasts a message with information on which file it is requesting, including host ID, length, file index, file name hash, etc., which portions of the file it wants sent in 4 kb blocks, up to 64 per request, and so on.

When a node that has the file receives the broadcast message requesting a file, it routes one or more replies, that include information on the file that it is sending, and up to 64 of the 4 k blocks of the file. If the file is larger than 64 blocks, or if any of the blocks are lost during transit, which the receiver can detect by timing out or other means, then the receiver can request more blocks. When it does so, it also includes information on what the last request was, so that the sender can efficiently manage the download. Because each request for more blocks consists of a new broadcast message, the route that blocks get sent back to the receiver can change throughout the transmission of a file.

The sender and receiver in a file transfer can compute SHA-1 hashes (see Secure Hash Standard, FIPS Pub. 180-1) of the file data, to ensure reliable transfer.

Finally, to accomplish an upload, the sender sends a broadcast message to the recipient requesting the upload, which the recipient can optionally accept.

Once the recipient accepts the upload, the recipient uploads the file as it would any other.
Key distribution—this application allows hosts on the network to exchange public keys so that they can directly connect to each other, which helps the network optimize itself. The preferred embodiment also distributes public keys for connection negotiation by periodically broadcasting them on the network. If a host encounters a new public key on the network, it can optionally accept it, often with user approval, and can optionally send a routed reply to the message with its own public key.
   Cryptography

Because the preferred embodiment requires a small trusted network to function efficiently, it benefits greatly from cryptography. Using public-key encryption for session key negotiation and user authentication allows both the prevention of unknown users from joining the network, as well as link data security to prevent unknown users from sniffing network traffic.

The invention also provides for an additional network name or ID that can be used to secure a network against people who do not have the name or ID. This can be useful if one wishes to prevent multiple networks from merging, or change it to remove access of user(s) without having to make everybody ban those user(s) public keys.

The invention preferably uses a cryptographically secure random number generator based on the implementation in the RSA reference code. The code uses a 32 byte state, with 16 bytes of counter and 16 bytes of system entropy constantly mixed in, and produces random values by using MD5.

The presently preferred embodiment accomplishes link level encryption using 1024 bit or higher RSA (see rsasecurity.com) to encrypt session keys, which are used for 448 bit Blowfish in CBC mode (a private key file encryption program that uses a CBC implementation of the BlowFish algorithm). The random number generator (RNG) should be cryptographically secure, based on the RNG in the RSAREF toolkit (see rsasecurity.com), it uses a 32 byte state with constant entropy infused in, using the message digest algorithm MD5 (see RFC 1321) to produce random values. When establishing session keys, a routine similar to ANSI X9.17 is applied to ensure less potential for RNG attack. Public keys are never sent in the clear over links, and the negotiation process is masked as much as possible to prevent easy detection/analysis. Those skilled in the art will appreciate that other encryption techniques can be substituted for those set forth above in connection with practice of the invention disclosed herein.

In the invention, connections use RSA with 1024 bit or greater public key sizes for exchange of 56 byte Blowfish session keys, and 8 byte PCBC initialization vectors.

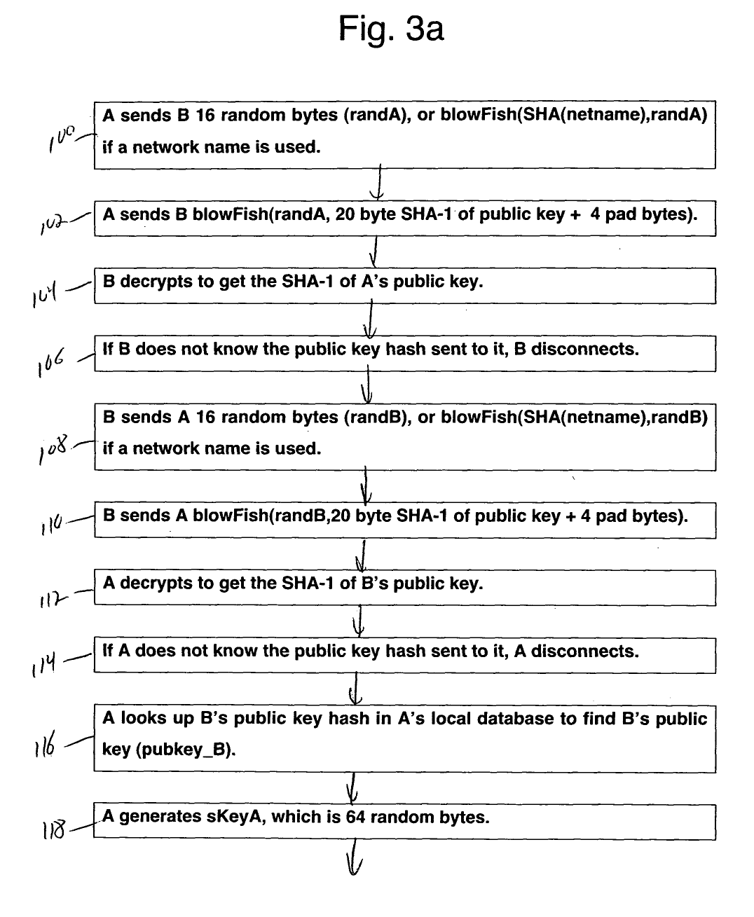

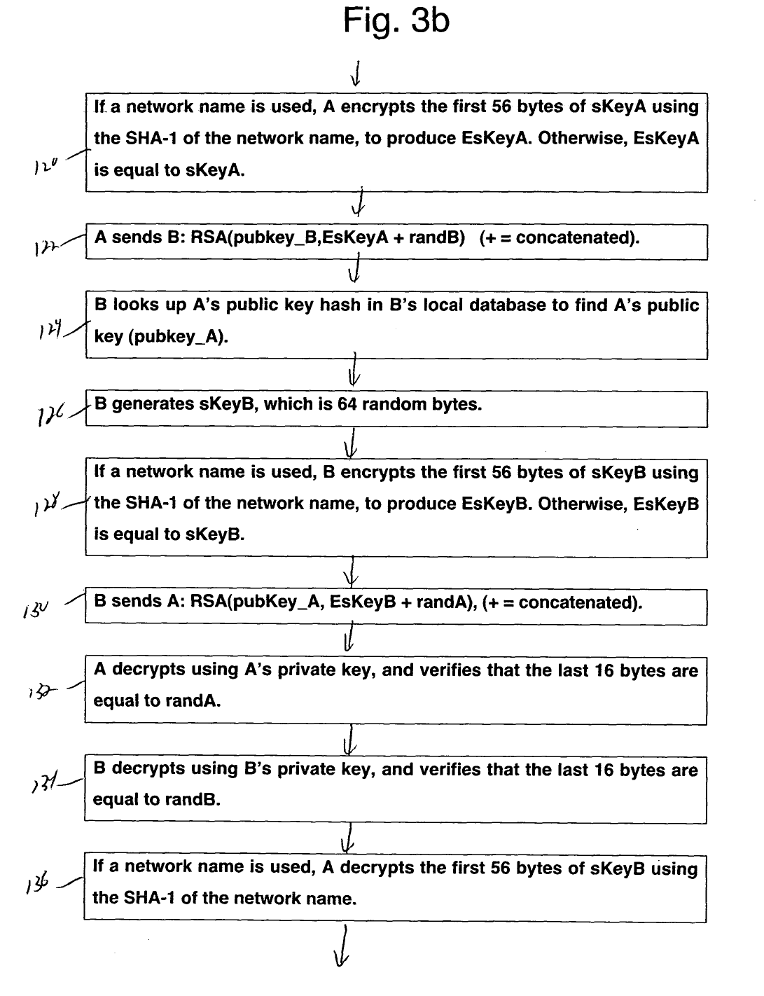

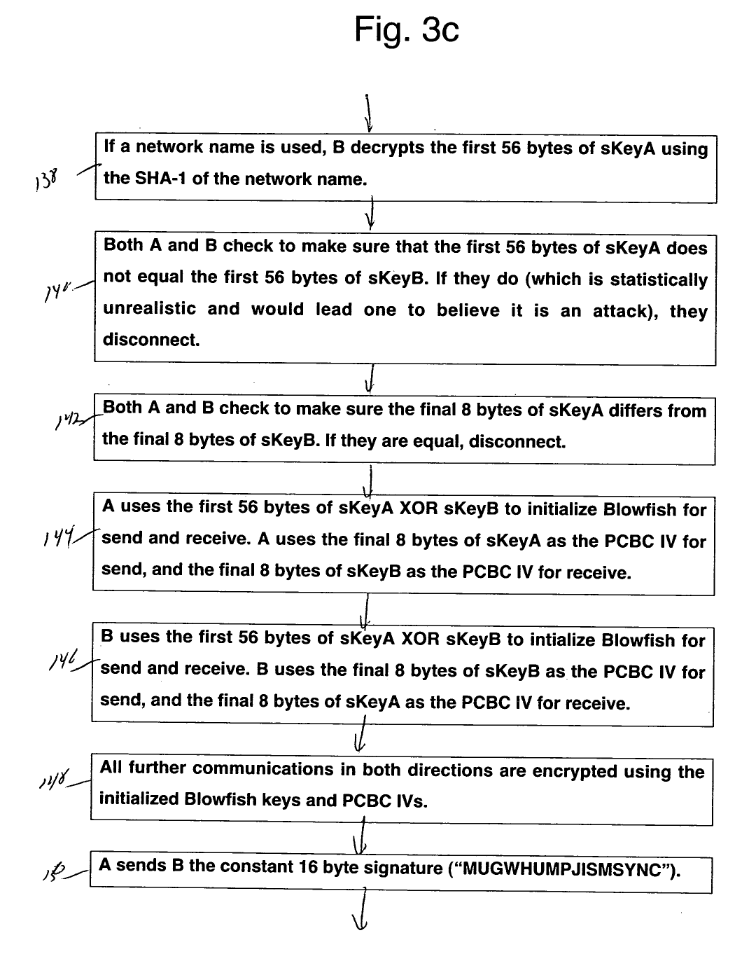

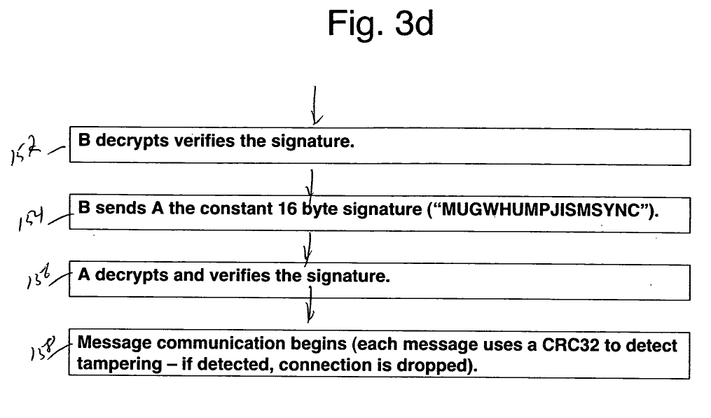

The link connection negotiation, where A is connecting to B, is a follows (see FIGS. 3a-3d):
1. A sends B 16 random bytes (randA), or blowFish(SHA(netname),randA) if a network name is used (100).
2. A sends B blowFish(randA, 20 byte SHA-1 of public key+4 pad bytes) (102).
3. B decrypts to get the SHA-1 of A's public key (104).
4. If B does not know the public key hash sent to it, B disconnects (106).
5. B sends A 16 random bytes (randB), or blowFish(SHA(netname),randB) if a network name is used (108).
6. B sends A blowFish(randB,20 byte SHA-1 of public key+4 pad bytes) (110).
7. A decrypts to get the SHA-1 of B's public key (112).
8. If A does not know the public key hash sent to it, A disconnects (114).
9. A looks up B's public key hash in A's local database to find B's public key (pubkey_B) (116).
10. A generates sKeyA, which is 64 random bytes (118).
11. If a network name is used, A encrypts the first 56 bytes of sKeyA using the SHA-1 of the network name, to produce EsKeyA. Otherwise, EsKeyA is equal to sKeyA (120).
12. A sends B: RSA(pubkey_B,EsKeyA+randB) (+=concatenated) (122).

13. B looks up A's public key hash in B's local database to find A's public key (pubkey_A) (124).
14. B generates sKeyB, which is 64 random bytes (126).
15. If a network name is used, B encrypts the first 56 bytes of sKeyB using the SHA-1 of the network name, to produce EsKeyB. Otherwise, EsKeyB is equal to sKeyB (128).
16. B sends A: RSA(pubKey_A, EsKeyB+randA), (+=concatenated) (130).
17. A decrypts using A's private key, and verifies that the last 16 bytes are equal to randA (132).
18. B decrypts using B's private key, and verifies that the last 16 bytes are equal to randB (134).
19. If a network name is used, A decrypts the first 56 bytes of sKeyB using the SHA-1 of the network name (136).
20. If a network name is used, B decrypts the first 56 bytes of sKeyA using the SHA-1 of the network name (138).
21. Both A and B check to make sure that the first 56 bytes of sKeyA does not equal the first 56 bytes of sKeyB. If they do (which is statistically unrealistic and would lead one to believe it is an attack), they disconnect (140).
22. Both A and B check to make sure the final 8 bytes of sKeyA differs from the final 8 bytes of sKeyB. If they are equal, disconnect (142).
23. A uses the first 56 bytes of sKeyA XOR sKeyB to initialize Blowfish for send and receive. A uses the final 8 bytes of sKeyA as the PCBC IV for send, and the final 8 bytes of sKeyB as the PCBC IV for receive (144).
24. B uses the first 56 bytes of sKeyA XOR sKeyB to initialize Blowfish for send and receive. B uses the final 8 bytes of sKeyB as the PCBC IV for send, and the final 8 bytes of sKeyA as the PCBC IV for receive (146).
25. All further communications in both directions are encrypted using the initialized Blowfish keys and PCBC Ivs (148).
26. A sends B the constant 16 byte signature (“MUGWHUMPJISMSYNC”) (150).
27. B decrypts verifies the signature (152).
28. B sends A the constant 16 byte signature (“MUGWHUMPJISMSYNC”) (154).
29. A decrypts and verifies the signature (156).
30. Message communication begins (each message uses a CRC32 to detect tampering—if detected, connection is dropped) (158).

Random Number Generation (RNG) is based on RSAREF's, but extended (uses 32 byte state, with 16 bytes counter, and 16 bytes of system entropy constantly mixed in, and which is taken when messages arrive, mouse movement, timing information on when connections come up, etc).

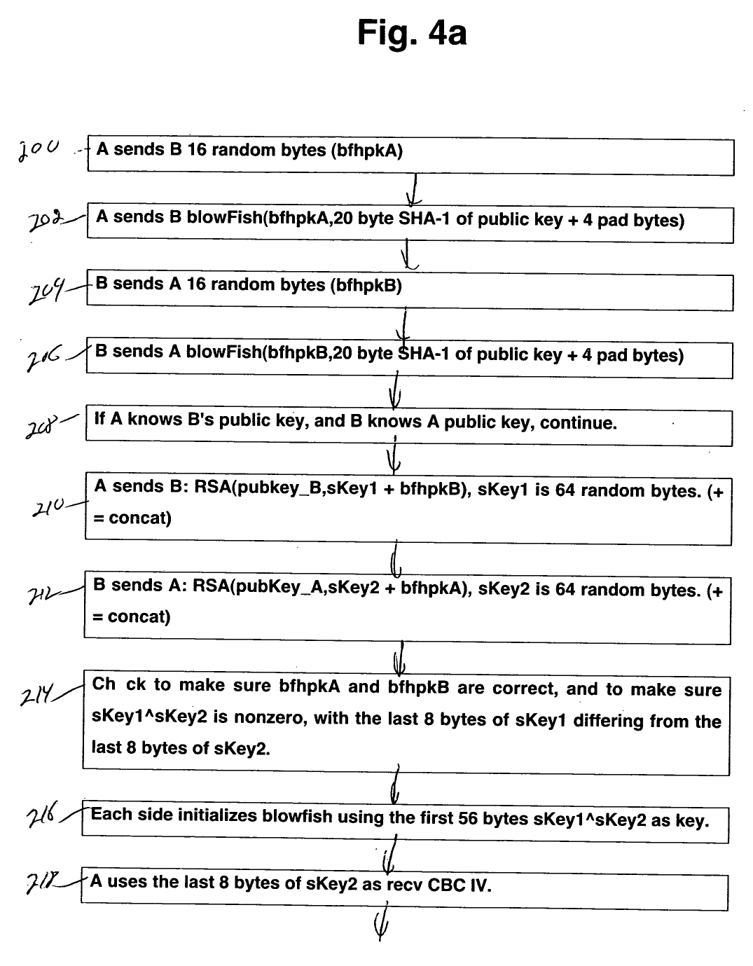

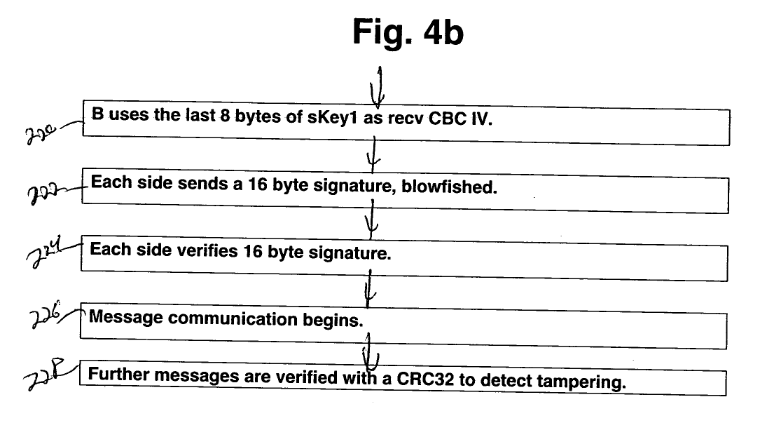

On connection (see FIGS. 4a and 4b):
1. A sends B 16 random bytes (bfhpka) (200).
2. A sends B blowFish(bfhpkA,20 byte SHA-1 of public key+4 pad bytes) (202).
3. B sends A 16 random bytes (bfhpkB) (204).
4. B sends A blowFish(bfhpkB,20 byte SHA-1 of public key+4 pad bytes) (206).
5. If A knows B's public key, and B knows A public key, continue (208)
6. A sends B: RSA(pubkey_B,sKey1+bfhpkB), skey1 is 64 random bytes. (+=concat) (210).
7. B sends A: RSA(pubKey_A,sKey2+bfhpka), sKey2 is 64 random bytes. (+=concat) (212).
8. Check to make sure bfhpkA and bfhpkB are correct, and to make sure sKey1AsKey2 is nonzero, with the last 8 bytes of sKey1 differing from the last 8 bytes of sKey2 (214).
9. Each side initializes blowfish using the first 56 bytes sKey1AsKey2 as key (216).
10. A uses the last 8 bytes of sKey2 as recv CBC IV (218).
11. B uses the last 8 bytes of sKey1 as recv CBC IV (220).
12. Each side sends a 16 byte signature, blowfished (222).
13. Each side verifies 16 byte signature (224).
14.Message communication begins (226).
15.Further messages are verified with a CRC32 to detect tampering (228).
   Operation

Operation of a presently preferred embodiment of the herein disclosed invention is as follows:
Download the system installer.
Run the installer. Select whatever directory is chosen to install to.
When prompted to do so, move the mouse around to generate randomness, move the mouse around until the progress bar is full.
A Profile Setup Wizard should appear. Enter a nickname to be known as on the network.
Select an approximate Internet connection speed, then hit Next.
Click ‘Run key generator . . . ’ which generates a key pair for use with the system.
Enter a password to encrypt a private key with. This prevents someone who gains access to the user's computer from stealing his private key. The password should be good and hard to guess. Then hit Generate.
At this time, move the mouse around in the Key Generator Window to generate randomness. There is enough randomness when the window says “Generating key pair . . . ”. When the generation is complete, the system gives a message box indicating how long it took to generate the key. Hit OK.
At this point, copy the public key to the clipboard using the button labeled “Copy my public key to the clipboard” and then paste it into an email/IM/whatever to give it to the person(s) to connect to.
Also acquire the public key of the person(s) to connect to via some means, and then click the “Import public keys . . . ” button to import their keys. Once their keys are imported, there should be a message in the setup wizard telling how many keys are loaded total.
Hit Next.
(Optionally) select a path to save new files in, and path(s) to allow people access to.
Hit Run.

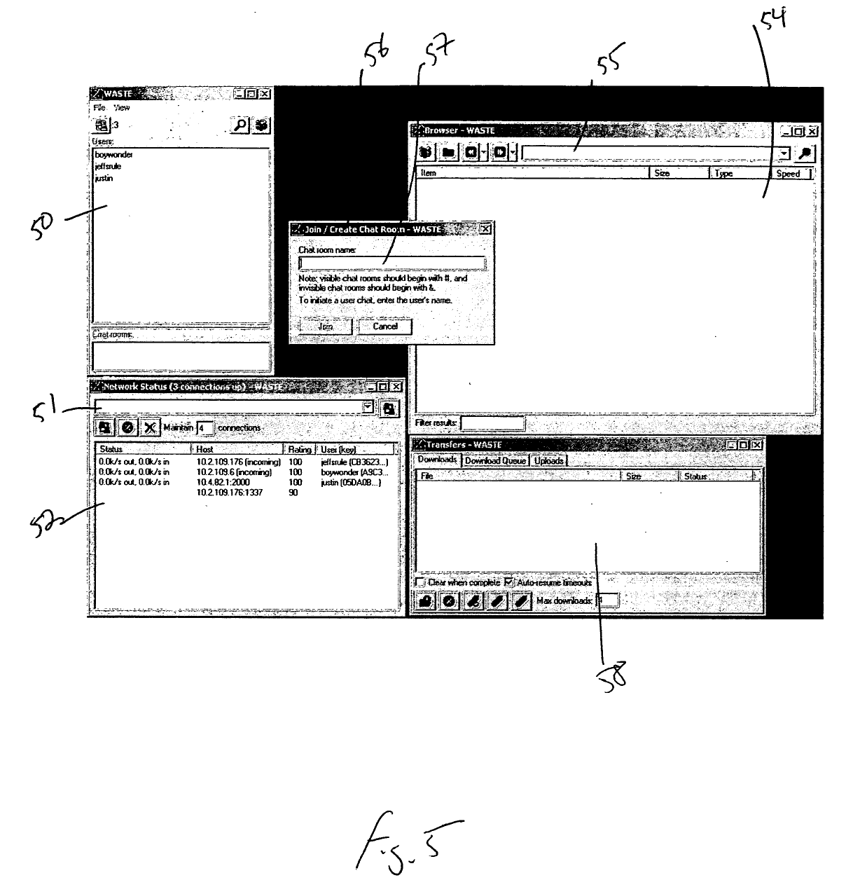

The system should open with two windows (see FIG. 5), a main “buddy-list” type window 50, and a “Network Status” window 52. Go to the text entry field 51at the top of the network status box, and type in the host name of the person to connect to. If when enter is hit something appears for a quick flash in the host list, and then disappears, it probably means that the parties do not have each others public keys. To double check the available keys, hit Ctrl+P to go to the preferences, then go to Network/Public Keys tab.

To browse the network, hit Alt+B to open the browser 54, then click the upper left icon in the browser window to refresh. One can also type in search terms into the browser address 55 at the top to search.

To enter a chat room, one brings up a chat room dialog 56 and enters a chat room name in the appropriate field 57. File transfers are managed from a file transfer dialog 58.

Although the invention is described herein with reference to the preferred embodiment, one skilled in the art will readily appreciate that other applications may be substituted for those set forth herein without departing from the spirit and scope of the present invention. Accordingly, the invention should only be limited by the claims included below.

1. An apparatus for secure distributed collaboration and communications, comprising:
a plurality of host systems which are accessible by one or more users;
a distributed ad-hoc network which is used for all communications between said host systems;
wherein direct connections between said host systems are not brought up on demand;
a mechanism for maintaining said network as a private network by only connecting or allowing connections between known users; and
a link layer encryption mechanism for encrypting all communications links between said hosts.

2. The apparatus of claim 1, wherein said network comprises any of:
a mechanism for implementing redundancy; and
a load-balancing mechanism

3. The apparatus of claim 1, further comprising:
at least one of said hosts on said network being accessible from everywhere on said network;
wherein firewalls do not impair function because all data transfer is accomplished through said network and said at least one of said hosts on said network is accessible from everywhere on said network.

4. The apparatus of claim 1, said network comprising a plurality of nodes, wherein at least one of said nodes comprises a mechanism for throttling bandwidth usage to optimize network use.

5. A method for communicating over a distributed peer-to-peer network between a plurality of hosts, comprising the steps of:
maintaining said network as a private network by only connecting or allowing connections between known users;
encrypting all communications links between said hosts with a link layer encryption mechanism;
exchanging user messages between said hosts via broadcast request routed reply method which comprises the steps of:
a sending host sending out a broadcast message to said network; and
zero or more hosts sending routed replies that follow a path of said broadcast message back to said sending host.

6. The method of claim 5, further comprising the step of:
using a unique ID for each new broadcast message, wherein each network node can track which broadcast messages it has seen, and wherein each network node can send routed messages back to a point of origin for an original broadcast message.

7. The method of claim 6, wherein a path that took the least time to broadcast is used for a routed reply.

8. The method of claim 5, further comprising the step of:
at least one node on said network deciding whether or not to rebroadcast or route traffic based on a connection type.

9. The method of claim 8, further comprising the step of:
each node organizing a queue of messages for each connection, and prioritizing messages in said queue as appropriate for optimal network performance.

10. The method of claim 5, further comprising the step of:
providing a message format having fields for any of:
verifying integrity of said message;
preventing broadcast messages from saturating said network;
providing information on the kind of message a message is, as well whether or not it is any of a broadcast message, routed message, or local message;
indicating message length;
message identification; and
message data.

11. A method for communicating over a distributed peer-to-peer network between a plurality of hosts, comprising the steps of:
maintaining said network as a private network by only connecting or allowing connections between known users;
encrypting all communications links between said hosts with a link layer encryption mechanism;
providing one or more services for use on said network.

12. The method of claim 11, wherein said step of providing one or more services for use on said network comprises the step of:
providing an instant messaging service for allowing users to communicate with other users;
wherein instant messages are broadcasted on said network, along with information on a sender and a recipient; and
wherein routed replies inform said sender of said instant message when said recipient has received said message and, optionally, how long said instant message took to go round trip.

13. The method of claim 11, wherein said step of providing one or more services for use on said network comprises the step of:
providing a group chat service for allowing two or more users to chat on said network;
wherein messages are broadcasted on said network, along with information on a sender and a destination channel name;
wherein automated notification messages are sent on said network; and
wherein routed replies are sent when a user receives a channel message, allowing a sender to see who on said channel has gotten said message and, if not, for determining that a user is no longer available.

14. The method of claim 11, wherein said step of providing one or more services for use on said network comprises the step of:
providing a distributed presence service for allowing users to see which other users are currently on said network.

15. The method of claim 14, wherein each user periodically broadcasts its existence on said network to allow other users to see when a new user comes on, and to detect when said new user is no longer broadcasting their existence.

16. The method of claim 14, wherein a user sends a broadcast message to request replies with user names to allow a user to get a full list of who is on said network; wherein a user detects when another user goes offline when no activity from said other user has been seen in a specified amount of time.

17. The method of claim 11, wherein said step of providing one or more services for use on said network comprises the step of:
providing a file browsing service for allowing a user to browse a virtual directory structure for each user on said network; wherein each user can specify a list of directories to make available to other users on said network; and wherein file browsing is accomplished by performing the steps of:
sending a broadcast message with a browse path to said network; and
each host sending routed replies as appropriate with any results that it may have.

18. The method of claim 11, wherein said step of providing one or more services for use on said network comprises the step of:
providing a file searching service for allowing a user to search other users' databases; wherein each user can specify a list of directories to make available to other users on said network; and wherein file searching is accomplished by performing the steps of:
sending a broadcast message with a search specification to said network; and
each host sending routed replies as appropriate with any results it may have.

19. The method of claim 11, wherein said step of providing one or more services for use on said network comprises the step of:
providing a file transfer service for allowing a user to transfer files to or from other users by performing the steps of:
when a node is to download a file, or portion of a file, from another node, a requesting node broadcasting a message with information on which file said node is requesting;
when a node that has said file receives said broadcast message requesting a file, said receiving node routing one or more replies, that include information on the file that it is sending, to said requesting node;
said requesting node and said receiving node optionally computing hashes of said file data, to ensure reliable transfer;
said requesting node sending a broadcast message to said receiving node requesting an upload, which said receiving node can optionally accept; and
once said receiving node accepts said upload request, said receiving load uploading said file.

20. The method of claim 11, wherein said step of providing one or more services for use on said network comprises the step of:
providing a key distribution service for allowing hosts on said network to exchange public keys so that they can directly connect to each other, wherein said key distribution service optionally distributes public keys for connection negotiation by periodically broadcasting them on said network.

21. The method of claim 11, said encrypting step further comprising the steps of:
using public-key encryption for session key negotiation and user authentication to prevent unknown users from joining said network; and
using link data security to prevent unknown users from sniffing network traffic.

22. The method of claim 11, said encrypting step further comprising the step of:
using an additional network name or ID to secure said network against users who do not have said network name or ID.

23. The method of claim 11, said encrypting step further comprising the step of:
using a cryptographically secure random number generator.

24. An apparatus for secure distributed collaboration and communications, comprising:
a plurality of host systems which are accessible by one or more users;
a distributed ad-hoc network which is used for all communications between said host systems;
wherein direct connections between said host systems are not brought up on demand;
a mechanism for maintaining said network as a private network by only connecting or allowing connections between known users; and
a link layer encryption mechanism for encrypting all communications links between said hosts, said link layer encryption mechanism comprising a link connection negotiation algorithm.

25. The apparatus of claim 24, said link layer encryption mechanism further comprising a random number generation algorithm,
